(19) United States
(12) Patent Application Publication
(10) Pub. No.: US 2025/0015971 A1
(43) Pub. Date: Jan. 9, 2025

(54) DATA PROCESSING METHODS AND APPARATUSES

(71) Applicant: ALIPAY (HANGZHOU) INFORMATION TECHNOLOGY CO., LTD., Hangzhou (CN)

(72) Inventors: Tianyi Li, Hangzhou (CN); Wuqiong Pan, Hangzhou (CN); Tingting Li, Hangzhou (CN); Tao Wei, Hangzhou (CN)

(73) Assignee: ALIPAY (HANGZHOU) INFORMATION TECHNOLOGY CO., LTD., Hangzhou (CN)

(21) Appl. No.: 18/891,524

(22) Filed: Sep. 20, 2024

Related U.S. Application Data
(63) Continuation of application No. PCT/CN2023/071485, filed on Jan. 10, 2023.

(30) Foreign Application Priority Data
Mar. 21, 2022 (CN) 202210275326.X

(51) Int. Cl. H04L 9/00; H04L 9/06; H04L 9/08

(52) U.S. Cl. CPC H04L 9/008; H04L 9/0618; H04L 9/0869; H04L 2209/46

(57) ABSTRACT

A computer-implemented method includes obtaining, by each secure multi-party computation (MPC) computation party of n secure MPC computation parties, a first data component sent by a data provider, obtained after the data provider splits to-be-processed data into n data components, and n is an integer not less than 3. M secure MPC computation parties are selected to respectively perform a shuffling operation on respectively held first data components, to obtain a second data component, so as to perform an MPC operation, wherein 1<m<n, and wherein m is a positive integer. Selecting m secure MPC computation parties is cyclically performed to perform a shuffling operation on first data components, until each secure MPC computation party is not selected for at least one time to perform the shuffling operation, where m secure MPC computation parties selected each time are not completely identical.

### CROSS-REFERENCE TO RELATED APPLICATIONS

This application is a continuation of PCT Application No. PCT/CN2023/071485, filed on Jan. 10, 2023, which claims priority to Chinese Patent Application No. 202210275326.X, filed on Mar. 21, 2022, and each application is hereby incorporated by reference in its entirety.

### TECHNICAL FIELD

One or more embodiments of this specification relate to the field of computer technologies, and in particular, to data processing methods and apparatuses.

### BACKGROUND

It is well known that data usually include a large amount of privacy and confidential information, and are collectively referred to as private data. Many institutions such as enterprises and hospitals protect the private data. How to share data without disclosing privacy in cryptography is an important problem. In such a background, secure multi-party computation (MPC) emerges. MPC means that a group of participants who do not trust each other can perform collaborative computing while protecting privacy. The participant is referred to as an MPC computation party.

However, in existing MPC data processing, one MPC computation party infers data of another MPC computation party based on data obtained after computation processing, thereby disclosing private data.

### SUMMARY

One or more embodiments of this specification describe data processing methods and apparatuses, to reduce a risk of disclosing private data.

According to a first aspect, a data processing method is provided, applied to a system including a data provider and N secure multi-party computation MPC computation parties, where N is an integer not less than 3, and the method includes: Each MPC computation party obtains a first data component sent by the data provider, where each first data component is one data component obtained after the data provider splits to-be-processed data into N data components; selecting M MPC computation parties to respectively perform a shuffling operation on respectively held first data components, to obtain a second data component, so as to perform an MPC operation, where 1<M<N, and M is a positive integer; and cyclically performing the operation of selecting M MPC computation parties to perform a shuffling operation on first data components, until each MPC computation party is not selected for at least one time to perform the shuffling operation, where M MPC computation parties selected each time are not completely the same.

In some possible implementations, that each MPC computation party performs the shuffling operation on a first data component held by the MPC computation party, to obtain a second data component includes: generating a plaintext array based on the first data component, where each element of the plaintext array uniquely corresponds to one piece of subdata in the first data component; shuffling elements of the plaintext array, to generate a plaintext random sequence; and performing the shuffling operation on the first data component based on the plaintext random sequence, to obtain the second data component.

In some possible implementations, the shuffling elements of the plaintext array, to generate a plaintext random sequence includes: generating a random array based on a random seed, where the random seed is obtained by M MPC participants through negotiation; and adjusting a location of each element of the plaintext array based on a value in the random array, to obtain the plaintext random sequence.

In some possible implementations, the value in the random array includes a first-type element value and a second-type element value; and the adjusting a location of each element of the plaintext array based on a value in the random array, to obtain the plaintext random sequence includes: sequentially determining values of elements of the random array; if a value of the j^{th} element of the random array is a first-type element value, interchanging the 1^{st} element and the (i+1)^{th} element that are of the plaintext array, where the j^{th} element of the random array corresponds to the i^{th} element of the plaintext array; or if a value of the j^{th} element of the random array is a second-type element value, performing no operation on the element of the plaintext array; and obtaining the plaintext random sequence until the elements of the plaintext array are adjusted based on all element values in the random array.

In some possible implementations, the performing the shuffling operation on the first data component based on the plaintext random sequence, to obtain the second data component includes: for each piece of subdata in the first data component, adjusting a location of the subdata in the first data component based on a location of an element corresponding to the subdata in the plaintext random sequence, to obtain the second data component.

In some possible implementations, each time of cyclically performing the operation of selecting M MPC computation parties to perform a shuffling operation on first data components, a second data component obtained in a previous cycle is reallocated to the N MPC computation parties.

In some possible implementations, each MPC computation party obtains at least two different first data components, and first data components held by the selected M MPC computation parties can include all the N data components into which the to-be-processed data are split; and that the second data component is allocated to the N MPC computation parties includes: generating N mask factors, where the sum of the N mask factors is 0; for each of N second data components obtained after the N data components are shuffled, computing the sum of each piece of subdata in the second data component and one mask factor, to obtain a masked second data component, where one second data component uniquely corresponds to one mask factor; and allocating all obtained masked second data components to the N MPC computation parties, so that second data components held by any M computation parties can include all the N data components into which the to-be-processed data are split.

In some possible implementations, each MPC computation party includes at least n MPC computation sub-parties, n is a positive integer, and n≥2; and in each cycle, before each MPC computation party performs the shuffling operation on the first data component held by the MPC computation party, the method further includes: splitting the first data component into n first subdata components; and simultaneously performing, by the n MPC computation sub-parties, the shuffling operation on the first subdata components, to obtain an intra-group shuffled first data component corresponding to a current MPC computation party.

According to a second aspect, a data processing apparatus is provided, applied to a system including a data provider and N secure multi-party computation MPC computation parties, where N is an integer not less than 3, and the apparatus includes: a data obtaining module, configured to obtain, by using each MPC computation party, a first data component sent by the data provider, where each first data component is one data component obtained after the data provider splits to-be-processed data into N data components; a data shuffling module, configured to select M MPC computation parties to respectively perform a shuffling operation on respectively held first data components obtained by the data obtaining module, to obtain a second data component, so as to perform an MPC operation, where 1<M<N, and M is a positive integer; and a cyclic execution module, configured to cyclically perform the operation that the data shuffling module selects M MPC computation parties to perform a shuffling operation on first data components, until each MPC computation party is not selected for at least one time to perform the shuffling operation, where M MPC computation parties selected each time are not completely the same.

According to a third aspect, a computing device is provided, including a memory and a processor. The memory stores executable code, and the processor executes the executable code, to implement the method according to any possible implementation of the first aspect.

According to the method and the apparatus provided in the embodiments of this specification, when the system including the data provider and the N MPC computation parties processes data, each MPC computation party obtains the first data component sent by the data provider, and then the M MPC computation parties are selected to perform the shuffling operation on respectively held first data components, to obtain the second data component used to perform an MPC operation. The operation of selecting M MPC computation parties is cyclically performed, so that each of the selected MPC computation parties is not selected for at least one time to perform the shuffling operation. Because the data provider splits the to-be-processed data into the N data components, the to-be-processed data are individually held by different MPC computation parties. Each MPC computation party shuffles a first data component held by the MPC computation party. In this way, when holders of data components exchange data, shuffled data components are exchanged. Therefore, it is difficult for any party to infer data of another party based on exchanged data, to reduce a risk of disclosing private data.

### BRIEF DESCRIPTION OF DRAWINGS

To describe the technical solutions in embodiments of this specification or in an existing technology more clearly, the following briefly describes the accompanying drawings needed for describing the embodiments or the existing technology. Clearly, the accompanying drawings in the following descriptions show some embodiments of this specification, and a person of ordinary skill in the art can still derive other drawings from these accompanying drawings without creative efforts.

FIG. 1 is a flowchart illustrating a data processing method, according to some embodiments of this specification;

FIG. 2 is an architectural diagram illustrating a system to which some embodiments of this application are applicable;

FIG. 3 is a flowchart illustrating a shuffling method, according to some embodiments of this specification;

FIG. 4 is a flowchart illustrating a shuffling method, according to some other embodiments of this specification;

FIG. 5 is a flowchart illustrating a shuffled data reallocation method, according to some embodiments of this specification; and

FIG. 6 is a schematic diagram illustrating a data processing apparatus, according to some embodiments of this specification.

### DESCRIPTION OF EMBODIMENTS

Secure multi-party computation (MPC) is a secure and efficient cryptographic computing method. In MPC, a plurality of participants can jointly complete one computing result based on data of the plurality of participants without disclosing the data. MPC has a significant advantage in a current environment in which large data computing and the public pay more attention on privacy security.

In a trusted-environment-based cryptographic computing (TECC) application scenario, an MPC computation party can be each trusted execution environment (TEE). By using a TEE technology, the MPC computation party can ensure that data of the MPC computation party only exist in the TEE. None of a host, an owner, etc. of the TEE can obtain a plaintext of the data (when the TEE is not broken through). In addition, each TEE accesses only a data component from the beginning to the end. In other words, even if an attacker breaks through a TEE and steals or modifies the data component for a long time period, valid information cannot be obtained. In a real system, it is almost impossible to break through such a defense. However, different computation parties or different data users process data and then exchange the data. Consequently, information may be disclosed.

For example, to ensure data security, when processing analysis is performed on data in a computing environment, the data are usually uploaded to a processing center in a ciphertext form for processing analysis, and then an analysis result is returned to a provider of the data or a requester of a processing result. In an entire analysis process, the processing center does not decrypt the data, and consequently, cannot obtain any information of the data. However, in data processing in which a plurality of parties participate, a plurality of participants need to exchange data. Consequently, one party easily infers data of another party based on a correlation of data processing. For example, a computation party sorts data for a plurality of times, and such sorting may enable one party to infer data of another computation party. For example, there is a specific probability that information about a related person in the data can be located based on both a person whose weight is ranked as the top 2 and a person whose income is ranked as the top 5, to disclose privacy.

Based on this, in this solution, it is considered that the MPC computation party shuffles the held data before each computation party processes data. In this way, it is ensured that each data holder cannot infer, based on exchanged data during data exchange, data held by another party, to ensure security of private data.

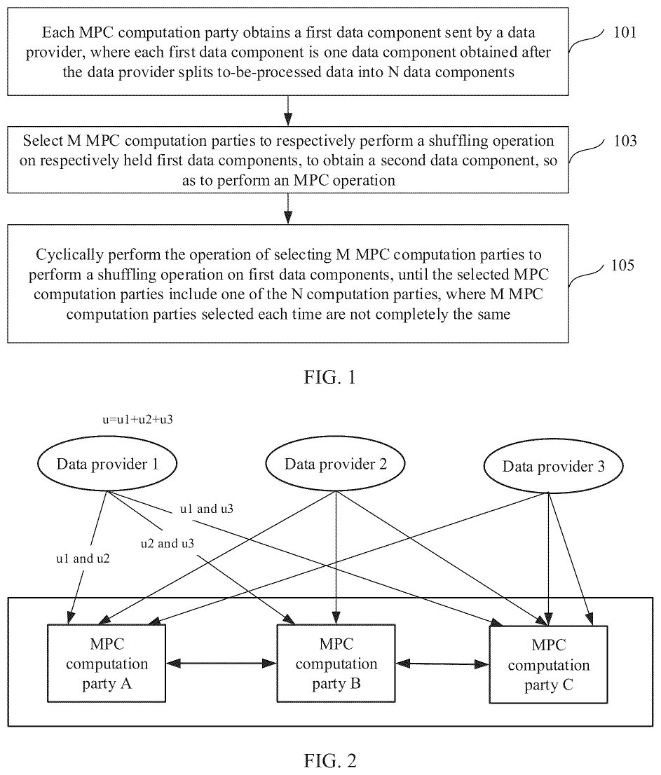

As shown in FIG. 1, some embodiments of this specification provide a data processing method. The method is applied to a system including a data provider and N secure multi-party computation MPC computation parties, where N is an integer not less than 3, and the method includes: Step 101: Each MPC computation party obtains a first data component sent by the data provider, where each first data component is one data component obtained after the data provider splits to-be-processed data into N data components. Step 103: Select M MPC computation parties to respectively perform a shuffling operation on respectively held first data components, to obtain a second data component, so as to perform an MPC operation, where 1<M<N, and M is a positive integer. Step 105: Cyclically perform the operation of selecting M MPC computation parties to perform a shuffling operation on first data components, until each MPC computation party is not selected for at least one time to perform the shuffling operation, where M MPC computation parties selected each time are not completely the same.

In the some embodiments, before performing processing analysis on data, the MPC computation party considers to first perform the shuffling operation on the data. For example, each MPC computation party can obtain the first data component sent by the data provider, and then the M MPC computation parties are selected to perform the shuffling operation on the respectively held first data components, to obtain the second data component used to perform the MPC operation. The operation of selecting M MPC computation parties is cyclically performed, so that each of the selected MPC computation parties is not selected for at least one time to perform the shuffling operation. Because the data provider splits the to-be-processed data into the N data components, the to-be-processed data are individually held by different MPC computation parties. Each MPC computation party shuffles a first data component held by the MPC computation party. In this way, when holders of data components exchange data, shuffled data components are exchanged. Therefore, the shuffled data cannot be associated with previous data. In other words, it is difficult for any party to infer data of another party based on exchanged data, to reduce a risk of disclosing private data.

The steps in FIG. 1 are individually described below with reference to specific embodiments.

First, in step 101, each MPC computation party obtains the first data component sent by the data provider, where each first data component is one data component obtained after the data provider splits the to-be-processed data into the N data components.

In this step, the data provider locally splits the to-be-processed data into the N data components. Here, N is a quantity of MPC computation parties that participate in processing of the to-be-processed data. Then, all first data components obtained through splitting are sent to all MPC computation parties.

For example, FIG. 2 is an architectural diagram illustrating a system to which some embodiments of this application are applicable. As shown in FIG. 2, the system includes a data provider and N MPC computation parties. N is an integer not less than 3, and that N is 3 is used as an example in FIG. 2. A data provider 1 (which described by using a data provider 1 in data providers 1, 2, and 3) splits data u into u1, u2, and u3; and then, provides u1 and u2 to an MPC computation party A, provides u2 and u3 to an MPC computation party B, and provides u3 and u1 to an MPC computation party C. In some possible implementations, the data provider 1 splits the data u into u1, u2, and u3; and then provides u1 to the MPC computation party A, provides u2 to the MPC computation party B, and provides u3 to the MPC computation party C. Further, the MPC computation party B can send u2 to the MPC computation party A, the MPC computation party C can send u3 to the MPC computation party B, and the MPC computation party A can send u1 to the MPC computation party C, so that the MPC computation party A holds u1 and u2, the MPC computation party B holds u2 and u3, and the MPC computation party C holds u3 and u1.

Certainly, each MPC computation party can obtain two first data components, or can obtain only one first data component or more first data components. However, each MPC computation party cannot obtain all of the N data components into which the to-be-processed data are split, to avoid a case in which an attacker can obtain valid information by breaking through one TEE.

In step 103, the M MPC computation parties are selected to respectively perform the shuffling operation on the respectively held first data components, to obtain the second data component, so as to perform the MPC operation.

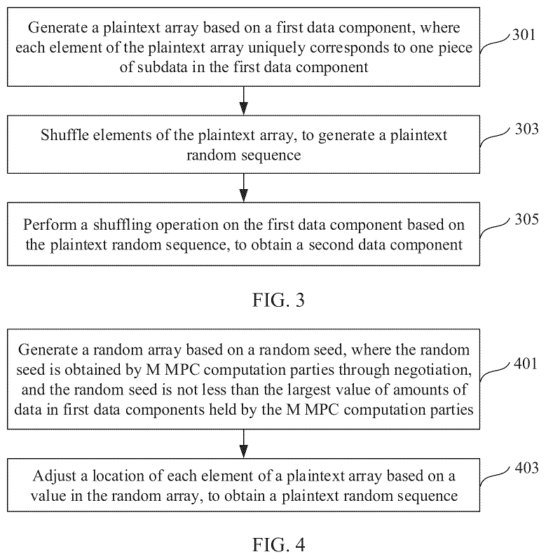

In this step, it is considered to select the M MPC computation parties from the N MPC computation parties to perform the shuffling operation on the respectively held first data components. As shown in FIG. 3, that each MPC computation party performs the shuffling operation on a first data component held by the MPC computation party, to obtain a second data component can be implemented in the following steps: Step 301: Generate a plaintext array based on the first data component, where each element of the plaintext array uniquely corresponds to one piece of subdata in the first data component. Step 303: Shuffle elements of the plaintext array, to generate a plaintext random sequence. Step 305: Perform the shuffling operation on the first data component based on the plaintext random sequence, to obtain the second data component.

In the some embodiments, it is first considered to generate a plaintext array based on the first data component. Each element of the plaintext array uniquely corresponds to one piece of subdata in the first data component. Then, the elements of the plaintext array are shuffled, to generate a plaintext random sequence, and then the first data component can be shuffled based on the plaintext random sequence. Because the plaintext random sequence is obtained by performing the shuffling operation, the second data component obtained based on the plaintext random sequence is also obtained by performing the shuffling operation. In this way, the shuffling operation is performed on the first data component.

Step 301 is described.

In step 301, it is considered to generate a plaintext array based on the first data component. It should be noted that each element of the plaintext array uniquely corresponds to one piece of subdata in the first data component. For example, if the first data component includes r pieces of subdata, and the r pieces of subdata are respectively [a₀, a₁, a₂, . . . , aᵣ₋₁], the generated plaintext array also needs to include r elements. For example, the plaintext array can be [y₀, y₁, y₂, . . . , yᵣ₋₁], and an element of the plaintext array corresponds to subdata that are in the first data component and that have the same subscript as the element. To be specific, a₀ corresponds to y₀, a₁ corresponds to y₁, a₂ corresponds to y₂, . . . , and aᵣ₋₁ corresponds to yᵣ₋₁. In this case, after the plaintext array is shuffled, locations of subdata in the first data component can be adjusted based on such a correspondence and locations of the shuffled elements, so that the first data component is shuffled.

Certainly, it should be noted that the first data component can be a data table. When the first data component is shuffled, it is considered to shuffle each row of the data table. In this way, each element of the plaintext array can uniquely correspond to one row of data in the data table.

Step 303 is described.

In step 303, the elements of the plaintext array generated in step 301 are shuffled, to generate a plaintext random sequence. As shown in FIG. 4, in some possible implementations, step 303 of shuffling elements of the plaintext array can be performed in the following steps: Step 401: Generate a random array based on a random seed, where the random seed is obtained by the M MPC computation parties through negotiation. Step 403: Adjust a location of each element of the plaintext array based on a value in the random array, to obtain the plaintext random sequence.

In some possible implementations, the random seed can be a value not less than the largest value of amounts of data in first data components held by the M MPC computation parties.

In the some embodiments, when the shuffling operation is performed on each element of the plaintext array, the selected M computation parties can first obtain a random seed through negotiation. The random seed is not less than the largest value of the amounts of data in the first data components held by the M MPC computation parties. Then, a random array is generated by using the random seed. Further, the location of each element of the plaintext array is adjusted based on the value in the random array, to obtain the plaintext random sequence.

For example, a random seed k is obtained by the M MPC computation parties through negotiation, and the random array obtained in a random generation manner is [x₀, x₁, x₂, . . . , xₖ₋₁]. In this case, determining can be performed based on a specified rule. For example, when x is a certain value, a location of an element at a corresponding location in the plaintext array needs to be adjusted or is not adjusted.

For example, a random number is generated by performing an operation such as addition, modulo, or right-moving on the random seed k obtained through negotiation. If the first data component includes n pieces of data, the operation of generating the random number is performed for n times, to obtain n random numbers, and the n random numbers form a random array.

In some possible implementations, the value in the random array includes a first-type element value and a second-type element value. In this case, step 403 of adjusting a location of each element of the plaintext array based on a value in the random array, to obtain the plaintext random sequence can be implemented in the following manner: sequentially determining values of elements of the random array; if a value of the j^{th} element of the random array is a first-type element value, interchanging the 1^{st} element and the (i+1)^{th} element that are of the plaintext array, where the j^{th} element of the random array corresponds to the i^{th} element of the plaintext array; or if a value of the j^{th} element of the random array is a second-type element value, performing no operation on the element of the plaintext array; and obtaining the plaintext random sequence until the elements of the plaintext array are adjusted based on all element values in the random array.

In the some embodiments, the value in the random array includes the first-type element value and the second-type element value. In this case, the values of the elements of the random array can be sequentially determined. If the value of the j^{th} element of the random array is a first-type element value, the 1^{st} element and the (i+1)^{th} element that are of the plaintext array are interchanged. If the value of the j^{th} element of the random array is a second-type element value, no operation is performed on the element of the plaintext array. In this way, the plaintext random sequence can be obtained until the elements of the plaintext array are adjusted based on all the element values in the random array. It can be learned that, because the random array is randomly generated, the plaintext random sequence obtained after the shuffling operation is performed on the plaintext array is also shuffled.

For example, values in the random array [x₀, x₁, x₂, . . . , xₖ₋₁] include two types of element values: 0 and 1. If the generated random array is [1, 0, 1, 0, 1], the plaintext array is Y=[y₀, y₁, y₂, y₃, y₄]. It is specified that elements are interchanged when the value in the random array is 1; and elements are not interchanged when the value in the random array is 0. Therefore, for the 1^{st} element x0=1 in the random array, the 1^{st} element and the (i+1)^{th} element that are of the plaintext array need to be interchanged. The 1^{st} element of the random array corresponds to the 1^{st} element, namely, y₀, of the plaintext array. In other words, the 1^{st} element and the 2^{nd} element that are of the plaintext array need to be interchanged. Therefore, a result obtained after the first time of interchanging is Y₁=[y₁, y₀, y₂, y₃, y₄]. Further, if the 2^{nd} element of the random array is 0, no operation is performed on the element of the plaintext array. Therefore, a result obtained at the second time is Y₂=Y₁=[y₁, y₀, y₂, y₃, y₄]. If the 3^{rd} element of the random array is 1, the 1^{st} element and the 4th element that are of the plaintext array are interchanged. Therefore, Y₃=[y₃, y₀, y₂, y₁, y₄]. The elements of the plaintext array are respectively interchanged sequentially based on the values in the random array.

It should be noted that, when the random array is generated, a quantity of elements of the random array can be one less than a quantity of elements of the plaintext array. Therefore, shuffling processing can be exactly performed on elements of each plaintext array. Certainly, the quantity of elements of the generated random array can be the same as the quantity of elements of the plaintext array. If the last element of the random array is 1, the last element and a previous element that are of the plaintext array can be interchanged.

Certainly, in some possible implementations, step 403 of adjusting a location of each element of the plaintext array based on a value in the random array, to obtain the plaintext random sequence can also be implemented based on a Fisher-Yates algorithm, a Knuth-Durstenfeld Shuffle algorithm, an Inside-Out algorithm, a reservoir sampling algorithm, etc.

Step 305 is described.

In step 305 of performing the shuffling operation on the first data component based on the plaintext random sequence, to obtain the second data component, it is considered that for each piece of subdata in the first data component, a location of the subdata in the first data component is adjusted based on a location of an element corresponding to the subdata in the plaintext random sequence, to obtain the second data component.

For example, the first data component is A=[a₀, a₁, a₂, a₃, a₄], and the plaintext random sequence is Y0=[y₃, y₀, y₂, y₁, y₄]. Here, subdata and an element that correspond to each other have the same subscript. Therefore, the first data component is adjusted based on the plaintext random sequence, so that A0=[a₃, a₀, a₂, a₁, a₄]. To be specific, the location of each piece of subdata in the first data component is adjusted based on a location of each element of the plaintext random sequence and a correspondence between each element and each piece of subdata in the first data component.

In step 105, the operation of selecting M MPC computation parties to perform a shuffling operation on first data components is cyclically performed, until the selected MPC computation parties include one of the N computation parties. The M MPC computation parties selected each time are not completely the same.

After the M MPC computation parties selected each time perform the shuffling operation, new M MPC computation parties are further selected to perform the shuffling operation, until each MPC computation party participates in the shuffling operation. Because different MPC computation parties hold different data components, each MPC computation party participates in the shuffling operation, to ensure that the shuffling operation is implemented for each data component in the shuffling operation. Therefore, security of data privacy is ensured.

Certainly, each time of cyclically performing the operation of selecting M MPC computation parties to perform a shuffling operation on first data components, a second data component obtained in a previous cycle needs to be reallocated to the N MPC computation parties. In other words, a data component obtained after a previous round of shuffling is reallocated to all MPC computation parties.

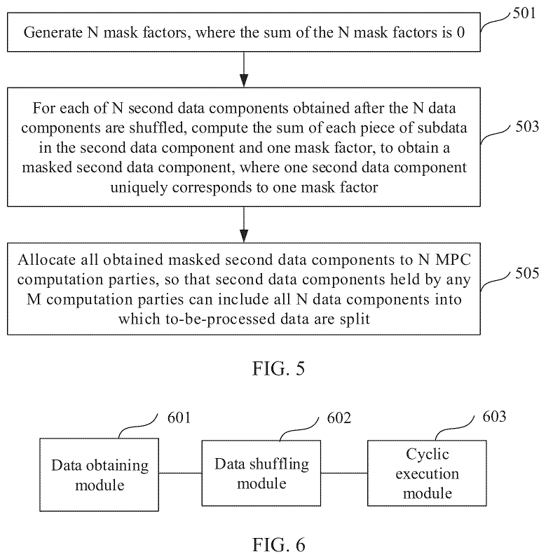

In some possible implementations, each MPC computation party obtains at least two different first data components, and first data components held by the selected M MPC computation parties can include all the N data components into which the to-be-processed data are split. In this case, as shown in FIG. 5, that the second data component is reallocated to the N MPC computation parties can be implemented in the following steps: Step 501: Generate N mask factors, where the sum of the N mask factors is 0. Step 503: For each of N second data components obtained after the N data components are shuffled, compute the sum of each piece of subdata in the second data component and one mask factor, to obtain a masked second data component, where one second data component uniquely corresponds to one mask factor. Step 505: Allocate all obtained masked second data components to the N MPC computation parties, so that second data components held by any M computation parties can include all the N data components into which the to-be-processed data are split.

In the some embodiments, when the second data component is reallocated to the N MPC computation parties, the N mask factors are randomly generated. The sum of the N mask factors is 0. Then, for each of N second data components obtained after the N data components are shuffled, the sum of each piece of subdata in the second data component and the mask factor is computed, to obtain the masked second data component. Further, all obtained masked second data components can be allocated to the N MPC computation parties, so that second data components held by any M MPC computation parties can include all the N data components into which the to-be-processed data are split. In this way, it is ensured in a mask manner that after shuffled data are reallocated, no MPC computation party can determine, by comparing data existing before shuffling and the shuffled data, specific processing performed on the data, to avoid disclosing private data.

Each data component is obtained by splitting the to-be-processed data, and all data obtained through splitting are combined to form the complete to-be-processed data. One mask factor is added to each shuffled second data component, to ensure that after a data component is reallocated, the MPC computation party cannot determine a specific operation previously performed on data, so as to reduce a risk of disclosing data. In addition, because the sum of all mask factors is 0, after all data components are combined into original data, the mask factors do not affect a value of the original data.

In some possible implementations, only one party can be selected in each round, and a data component of the party can be shared with an uninformed party in the current round, to perform a next round of operation, and all MPC computation parties do not need to perform re-sharing, thereby improving execution efficiency of a processor.

When the MPC computation party performs data shuffling processing, a data amount is usually very large. This seriously affects data processing efficiency. Therefore, in some possible implementations, it can be considered to further split each data component into subdata components, and different computation sub-parties in the MPC computation party perform parallel processing on each piece of subdata. For example, each MPC computation party includes at least n MPC computation sub-parties, n is a positive integer, and n≥2.

In each cycle, before each MPC computation party performs the shuffling operation on the first data component held by the MPC computation party, the first data component can be further split into n first subdata components; and the n MPC computation sub-parties simultaneously perform the shuffling operation on the first subdata components, to obtain an intra-group shuffled first data component corresponding to a current MPC computation party.

That is, after obtaining a data component, a different MPC computation party first splits the data component into subdata components, and then performs intra-group shuffling on the subdata components by using respective MPC computation sub-parties. Then, inter-group shuffling, namely, shuffling between MPC computation parties in the above-mentioned embodiments is performed. In this way, a plurality of computation sub-parties perform parallel processing through intra-group shuffling and then inter-group shuffling, to greatly improve execution efficiency of the MPC computation party. Certainly, in some possible implementations, after intra-group shuffling and inter-group shuffling are completed, intra-group shuffling can be further performed once.

Certainly, in some possible implementations, when the shuffling operation is performed on the to-be-processed data, each computation party can perform only intra-group shuffling, and does not need to perform inter-group shuffling or intra-group shuffling performed again after inter-group shuffling. In this way, processing efficiency can be greatly improved when a data amount is relatively large.

As shown in FIG. 6, this specification provides a data processing apparatus, applied to a system including a data provider and N secure multi-party computation MPC computation parties, where N is an integer not less than 3, and the apparatus includes: a data obtaining module 601, configured to obtain, by using each MPC computation party, a first data component sent by the data provider, where each first data component is one data component obtained after the data provider splits to-be-processed data into N data components; a data shuffling module 602, configured to select M MPC computation parties to respectively perform a shuffling operation on respectively held first data components obtained by the data obtaining module 601, to obtain a second data component, so as to perform an MPC operation, where 1<M<N, and M is a positive integer; and a cyclic execution module 603, configured to cyclically perform the operation that the data shuffling module 602 selects M MPC computation parties to perform the shuffling operation on first data components, until each MPC computation party is not selected for at least one time to perform the shuffling operation, where M MPC computation parties selected each time are not completely the same.

In some possible implementations, when each MPC computation party performs the shuffling operation on the first data component held by the MPC computation party, to obtain the second data component, the data shuffling module 602 is configured to perform the following operations: generating a plaintext array based on the first data component, where each element of the plaintext array uniquely corresponds to one piece of subdata in the first data component; shuffling elements of the plaintext array, to generate a plaintext random sequence; and performing the shuffling operation on the first data component based on the plaintext random sequence, to obtain the second data component.

In some possible implementations, when shuffling the elements of the plaintext array, to generate a plaintext random sequence, the data shuffling module 602 is configured to perform the following operations: generating a random array based on a random seed, where the random seed is obtained by M MPC participants through negotiation; and adjusting a location of each element of the plaintext array based on a value in the random array, to obtain the plaintext random sequence.

In some possible implementations, the value in the random array includes a first-type element value and a second-type element value; and when adjusting the location of each element of the plaintext array based on the value in the random array, to obtain the plaintext random sequence, the data shuffling module 602 is configured to perform the following operations: sequentially determining values of elements of the random array; if a value of the j^{th} element of the random array is a first-type element value, interchanging the 1^{st} element and the (i+1)^{th} element that are of the plaintext array, where the j^{th} element of the random array corresponds to the i^{th} element of the plaintext array; or if a value of the j^{th} element of the random array is a second-type element value, performing no operation on the element of the plaintext array; and obtaining the plaintext random sequence until the elements of the plaintext array are adjusted based on all element values in the random array.

In some possible implementations, when performing the shuffling operation on the first data component based on the plaintext random sequence, to obtain the second data component, the data shuffling module 602 is configured to perform the following operations: for each piece of subdata in the first data component, adjusting a location of the subdata in the first data component based on a location of an element corresponding to the subdata in the plaintext random sequence, to obtain the second data component.

In some possible implementations, each time of cyclically performing the operation of selecting M MPC computation parties to perform the shuffling operation on first data components, the cyclic execution module 603 reallocates a second data component obtained in a previous cycle to the N MPC computation parties.

In some possible implementations, each MPC computation party obtains at least two different first data components, and first data components held by the selected M MPC computation parties can include all the N data components into which the to-be-processed data are split; and when the second data component is allocated to the N MPC computation parties, the cyclic execution module 603 is configured to perform the following operations: generating N mask factors, where the sum of the N mask factors is 0; for each of N second data components obtained after the N data components are shuffled, computing the sum of each piece of subdata in the second data component and one mask factor, to obtain a masked second data component, where one second data component uniquely corresponds to one mask factor; and allocating all obtained masked second data components to the N MPC computation parties, so that second data components held by any M computation parties can include all the N data components into which the to-be-processed data are split.

In some possible implementations, each MPC computation party includes at least n MPC computation sub-parties, n is a positive integer, and n≥2; the apparatus further includes a parallel shuffling module; and in each cycle, before each MPC computation party performs the shuffling operation on the first data component held by the MPC computation party, the parallel shuffling module is configured to perform the following operations: splitting the first data component into n first subdata components; and simultaneously performing, by the n MPC computation sub-parties, the shuffling operation on the first subdata component, to obtain an intra-group shuffled first data component corresponding to a current MPC computation party.

This specification further provides a computer-readable storage medium. The computer-readable storage medium stores a computer program. When the computer program is executed on a computer, the computer is enabled to perform the method according to any embodiment of this specification.

This specification further provides a computing device, including a memory and a processor. The memory stores executable code, and when executing the executable code, the processor implements the method according to any embodiment of this specification.

It can be understood that the structure shown in the embodiments of this specification does not constitute a specific limitation on the data processing apparatus. In some other embodiments of this specification, the data processing apparatus can include more or fewer components than those shown in the figure, or combine some components, or split some components, or have different component arrangements. The illustrated components can be implemented by hardware, software, or a combination of software and hardware.

Content such as information exchange and execution processes between units in the apparatus is based on the same concept as that in the method embodiment of this specification. For specific content, references can be to the descriptions in the method embodiment of this specification. Details are omitted here for simplicity.

A person skilled in the art should be aware that in the above-mentioned one or more examples, functions described in this specification can be implemented by hardware, software, firmware, or any combination thereof. When implemented by using software, these functions can be stored in a computer-readable medium or transmitted as one or more instructions or code on a computer-readable medium.

In the above-mentioned specific implementations, the objectives, technical solutions, and beneficial effects of this specification are further described in detail. It should be understood that the above-mentioned descriptions are merely specific implementations of this application, but are not intended to limit the protection scope of this application. Any modification, equivalent replacement, improvement, or the like made based on the technical solutions of this application shall fall within the protection scope of this application.

What is claimed is:

1. A computer-implemented method for data processing, comprising:
obtaining, by each secure multi-party computation (MPC) computation party of n secure MPC computation parties, a first data component sent by a data provider, wherein each first data component is one data component obtained after the data provider splits to-be-processed data into n data components, wherein n is an integer not less than 3;
selecting m secure MPC computation parties of the n secure MPC computation parties to respectively perform a shuffling operation on respectively held first data components, to obtain a second data component, so as to perform an MPC operation, wherein 1<m<n, and wherein m is a positive integer; and
cyclically performing selecting m secure MPC computation parties to perform a shuffling operation on first data components, until each secure MPC computation party is not selected for at least one time to perform the shuffling operation, wherein m secure MPC computation parties selected each time are not completely identical.

2. The computer-implemented method of claim 1, wherein performing, by each secure MPC computation party, the shuffling operation on a first data component held by the secure MPC computation party, to obtain a second data component, comprises:
generating a plaintext array based on the first data component, wherein each element of the plaintext array uniquely corresponds to one piece of subdata in the first data component;
shuffling elements of the plaintext array, to generate a plaintext random sequence; and
performing the shuffling operation on the first data component based on the plaintext random sequence, to obtain the second data component.

3. The computer-implemented method of claim 2, wherein shuffling elements of the plaintext array, to generate a plaintext random sequence, comprises:
generating a random array based on a random seed, wherein the random seed is obtained by m secure MPC participants through negotiation; and
adjusting a location of each element of the plaintext array based on a value in the random array, to obtain the plaintext random sequence.

4. The computer-implemented method of claim 3, wherein:
the value in the random array comprises a first-type element value and a second-type element value; and
the adjusting a location of each element of the plaintext array based on a value in the random array, to obtain the plaintext random sequence comprises:
sequentially determining values of elements of the random array;
if a value of the j^{th} element of the random array is a first-type element value, interchanging the 1^{st} element and the (i+1)^{th} element that are of the plaintext array, wherein the j^{th} element of the random array corresponds to the i^{th} element of the plaintext array; or
if a value of the j^{th} element of the random array is a second-type element value, performing no operation on the element of the plaintext array; and
obtaining the plaintext random sequence until the elements of the plaintext array are adjusted based on all element values in the random array.

5. The computer-implemented method of claim 2, wherein performing, by each secure MPC computation party, the shuffling operation on the first data component based on the plaintext random sequence, to obtain the second data component, comprises:
for each piece of subdata in the first data component, adjusting a location of the subdata in the first data component based on a location of an element corresponding to the subdata in the plaintext random sequence, to obtain the second data component.

6. The computer-implemented method of claim 1, wherein each time of cyclically performing selecting m secure MPC computation parties to perform a shuffling operation on first data components, a second data component obtained in a previous cycle is reallocated to the n secure MPC computation parties.

7. The computer-implemented method of claim 6, wherein:
each secure MPC computation party obtains at least two different first data components;
first data components held by the selected m secure MPC computation parties can comprise all the n data components into which the to-be-processed data are split; and
the second data component is allocated to the n secure MPC computation parties by:
generating n mask factors, wherein a sum of the n mask factors is 0;
for each of n second data components obtained after the N data components are shuffled, computing a sum of each piece of subdata in the second data component and one mask factor, to obtain a masked second data component, wherein one second data component uniquely corresponds to one mask factor; and
allocating all obtained masked second data components to the n secure MPC computation parties, so that second data components held by any m computation parties can comprise all the n data components into which the to-be-processed data are split.

8. The computer-implemented method of claim 1, wherein:
each secure MPC computation party comprises at least n secure MPC computation sub-parties, n is a positive integer, and n≥2.

9. The computer-implemented method of claim 8, wherein:
in each cycle, before the performing, by each secure MPC computation party, the shuffling operation on a first data component held by the secure MPC computation party:
splitting the first data component into n first subdata components; and
simultaneously performing, by the n secure MPC computation sub-parties, the shuffling operation on the n first subdata components, to obtain an intra-group shuffled first data component corresponding to a current secure MPC computation party.

10. A non-transitory, computer-readable medium storing one or more instructions executable by a computer system to perform one or more operations for data processing, comprising:
obtaining, by each secure multi-party computation (MPC) computation party of n secure MPC computation parties, a first data component sent by a data provider, wherein each first data component is one data component obtained after the data provider splits to-be-processed data into n data components, wherein n is an integer not less than 3;
selecting m secure MPC computation parties of the n secure MPC computation parties to respectively perform a shuffling operation on respectively held first data components, to obtain a second data component, so as to perform an MPC operation, wherein 1<m<n, and wherein m is a positive integer; and
cyclically performing selecting m secure MPC computation parties to perform a shuffling operation on first data components, until each secure MPC computation party is not selected for at least one time to perform the shuffling operation, wherein m secure MPC computation parties selected each time are not completely identical.

11. The non-transitory, computer-readable medium of claim 10, wherein performing, by each secure MPC computation party, the shuffling operation on a first data component held by the secure MPC computation party, to obtain a second data component, comprises:
generating a plaintext array based on the first data component, wherein each element of the plaintext array uniquely corresponds to one piece of subdata in the first data component;
shuffling elements of the plaintext array, to generate a plaintext random sequence; and
performing the shuffling operation on the first data component based on the plaintext random sequence, to obtain the second data component.

12. The non-transitory, computer-readable medium of claim 11, wherein shuffling elements of the plaintext array, to generate a plaintext random sequence, comprises:
generating a random array based on a random seed, wherein the random seed is obtained by m secure MPC participants through negotiation; and
adjusting a location of each element of the plaintext array based on a value in the random array, to obtain the plaintext random sequence.

13. The non-transitory, computer-readable medium of claim 12, wherein:
the value in the random array comprises a first-type element value and a second-type element value; and
the adjusting a location of each element of the plaintext array based on a value in the random array, to obtain the plaintext random sequence comprises:
sequentially determining values of elements of the random array;
if a value of the j^{th} element of the random array is a first-type element value, interchanging the 1^{st} element and the (i+1)^{th} element that are of the plaintext array, wherein the j^{th} element of the random array corresponds to the i^{th} element of the plaintext array; or
if a value of the j^{th} element of the random array is a second-type element value, performing no operation on the element of the plaintext array; and
obtaining the plaintext random sequence until the elements of the plaintext array are adjusted based on all element values in the random array.

14. The non-transitory, computer-readable medium of claim 11, wherein performing, by each secure MPC computation party, the shuffling operation on the first data component based on the plaintext random sequence, to obtain the second data component, comprises:
for each piece of subdata in the first data component, adjusting a location of the subdata in the first data component based on a location of an element corresponding to the subdata in the plaintext random sequence, to obtain the second data component.

15. The non-transitory, computer-readable medium of claim 10, wherein each time of cyclically performing selecting m secure MPC computation parties to perform a shuffling operation on first data components, a second data component obtained in a previous cycle is reallocated to the n secure MPC computation parties.

16. The non-transitory, computer-readable medium of claim 15, wherein:
each secure MPC computation party obtains at least two different first data components;
first data components held by the selected m secure MPC computation parties can comprise all the n data components into which the to-be-processed data are split; and
the second data component is allocated to the n secure MPC computation parties by:
generating n mask factors, wherein a sum of the n mask factors is 0;
for each of n second data components obtained after the N data components are shuffled, computing a sum of each piece of subdata in the second data component and one mask factor, to obtain a masked second data component, wherein one second data component uniquely corresponds to one mask factor; and
allocating all obtained masked second data components to the n secure MPC computation parties, so that second data components held by any m computation parties can comprise all the n data components into which the to-be-processed data are split.

17. The non-transitory, computer-readable medium of claim 10, wherein:
each secure MPC computation party comprises at least n secure MPC computation sub-parties, n is a positive integer, and n≥2.

18. The non-transitory, computer-readable medium of claim 17, wherein:
in each cycle, before the performing, by each secure MPC computation party, the shuffling operation on a first data component held by the secure MPC computation party:
splitting the first data component into n first subdata components; and
simultaneously performing, by the n secure MPC computation sub-parties, the shuffling operation on the n first subdata components, to obtain an intra-group shuffled first data component corresponding to a current secure MPC computation party.

19. A computer-implemented system for data processing, comprising:
one or more computers; and
one or more computer memory devices interoperably coupled with the one or more computers and having tangible, non-transitory, machine-readable media storing one or more instructions that, when executed by the one or more computers, perform one or more operations, comprising:
obtaining, by each secure multi-party computation (MPC) computation party of n secure MPC computation parties, a first data component sent by a data provider, wherein each first data component is one data component obtained after the data provider splits to-be-processed data into n data components, wherein n is an integer not less than 3;
selecting m secure MPC computation parties of the n secure MPC computation parties to respectively perform a shuffling operation on respectively held first data components, to obtain a second data component, so as to perform an MPC operation, wherein 1<m<n, and wherein m is a positive integer; and
cyclically performing selecting m secure MPC computation parties to perform a shuffling operation on first data components, until each secure MPC computation party is not selected for at least one time to perform the shuffling operation, wherein m secure MPC computation parties selected each time are not completely identical.

20. The computer-implemented system of claim 19, wherein performing, by each secure MPC computation party, the shuffling operation on a first data component held by the secure MPC computation party, to obtain a second data component, comprises:
generating a plaintext array based on the first data component, wherein each element of the plaintext array uniquely corresponds to one piece of subdata in the first data component;
shuffling elements of the plaintext array, to generate a plaintext random sequence; and
performing the shuffling operation on the first data component based on the plaintext random sequence, to obtain the second data component.
